(19) United States
(12) Patent Application Publication
(10) Pub. No.: US 2010/0028522 A1
(43) Pub. Date: Feb. 4, 2010

(54) FRUIT-BASED FATTY STUFFING OR SPREAD

(76) Inventors: Jean-Luc Rabault, Breuillet (FR); Flavien Lambert, Clamart (FR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/515,229

(22) PCT Filed: Nov. 15, 2007
(86) PCT No.: PCT/EP2007/062402

§ 371 Date: Jun. 15, 2009

(30) Foreign Application Priority Data
Nov. 16, 2006 (FR) 06/10025

(51) Int. Cl. A23L 1/212; A23L 1/0522; A23L 1/064

(52) U.S. Cl. 426/578

(57) ABSTRACT

The invention relates to a fruit-based fatty stuffing or spread comprising a suspension of solid particles in a continuous fatty phase containing at least one sweetening agent in a amount lower than 45 wt %, less than 3 wt % and advantageously less 1 wt % of non fatty dried cocoa, and having a fatty material content of between 23 and 38 wt %, characterised in that it contains milk powder and/or dairy derivatives powder and/or dry starch and between 3 and 20 wt % of a fruit powder, the fruit powder having a D₉₀ lower than 500 μm and a water content lower than 8 wt %, the content of (milk powder+diary derivatives powder+dry starch) being higher than 25 wt %. The invention further relates to a method for producing the fatty stuffing or spread and to the use thereof in a food product.

The present invention relates to fatty stuffings or spreads flavored with fruit, i.e. with a taste and color of “natural” fruit, not very sticky (unlike jams), while having a good nutritional composition and substantial fruit equivalent content.

Aqueous stuffings containing fruit are known:
in chocolate tablets: the aqueous phase is notably recognized by the presence of a preservative (potassium sorbate) and/or by the strong sugar content for lowering Aw and/or by strong acidity (these 3 characteristics providing preservation). These stuffings also have the drawback of being very sticky, notably in the case of breakage/leakage of the tablet, in the fingers (hands have to be washed subsequently).
in sandwiched biscuits of the strawberry BN type, which use strawberry pulp giving a sticky stuffing and which contains many sugars, and/or polyols (in order to lower Aw) and the fruit equivalent content of which is low.

Alcoholic flavored stuffings with fruit are also known. But the taste is neither natural nor healthy for children and the inside being liquid, the product is very sticky in the case of leakage, and not easy to eat otherwise than in mouthfuls.

Fruit powder seems to be a good candidate for flavoring and coloring fatty stuffings and spreads, provided that they only provide very little water. However, even dry, the fruit may pose the following problem:
Increase in the viscosity and yield stress, notably related to the fact that the pieces of fruit are reduced into a very fine powder during the process and to the fact that the fruit powder is very hygroscopic.

Now, the inventors have surprisingly discovered that it is possible to flavor fatty stuffings or spreads by using natural fruit powders associated with milk and/or dairy derivative powders and/or with dry starch while giving the fatty stuffing or spread the natural color of fruit, while retaining good nutritional properties to the fatty stuffings or spreads (not too much sugar or fat, no artificial additives such as a flavoring or coloring agent), while avoiding that it is too sticky or too liquid and by using a very simple making process, i.e. without the problems of the prior art.

The present invention therefore relates to a fatty stuffing or spread with fruit consisting of a suspension of solid particles in a continuous fatty phase, comprising at least one sugaring agent with a content of less than 45% by weight based on the total weight of the fatty stuffing or spread, less than 3% by weight of non-fatty dry cocoa based on the total weight of the fatty stuffing or spread, advantageously less than 1% by weight based on the total weight of the fatty stuffing or spread, and with a fat content comprised between 23 and 38% by weight based on the total weight of the fatty stuffing or spread, and, characterized in that it contains milk and/or dairy derivative powder and/or dry starch and between 3 and 20% by weight of a fruit powder, based on the total weight of the fatty stuffing or spread, the fruit powder having a D₉₀ less than 500 μm, and a water content less than 8% by weight based on the total weight of the fruit powder, the (milk powder+dairy derivative powder+dry starch) content being above 25% by weight.

In the sense of the present invention, by “fatty stuffing or spread” is meant any concentrated suspension of solid particles in a continuous fatty phase which is not a water-in-oil emulsion. The compositions are close to chocolate and the like but are mainly distinguished by the nature of the softer fatty materials: the SFC_{20° C.} (Solid Fat Content measured at 20° C.) is less than 50%, whence a generally non-crisp texture at 20° C. Typical examples of fats which may be used in the fatty stuffing according to the invention are mixtures of 70% palm oil and 30% hydrogenated palm kernel oil (melting point 31° C.), 50% palm oil and 50% hydrogenated coconut oil (melting point 30° C.), AMF (anhydrous milk fat) and rapeseed oil or AMF and hazelnut oil. The fatty stuffings are generally used in the “inside” (either completely included in a chocolate shell, a cake or a biscuit, or partly included (tartlet, sandwiched biscuit . . . )). Fatty spreads have a texture of an ointment/a spread for which the consistence may be more or less viscous.

In the remainder of the application, the term “fatty stuffings” encompasses fatty stuffings and spreads, unless specified otherwise.

Advantageously, the fat content of the fatty stuffing according to the present invention is comprised between 23 and 35% by weight based on the total weight of the fatty stuffing, in an advantageous way between 23 and 33% by weight based on the total weight of the fatty stuffing, still more advantageously between 26 and 30% by weight based on the total weight of the fatty stuffing.

In the sense of the present invention, by “sugaring agent” is meant any sugar (mono- and disaccharides), glucose and/or fructose syrups, maltodextrins, polyols, and intense sweeteners. Among monosaccharides mention may be made of fructose, galactose, glucose. Among disaccharides, mention may notably be made of saccharose which is the sugar currently used for making fatty stuffings, but saccharose may be partly or totally replaced with another disaccharide such as lactose, for example in an amount of 0-50% by weight, or with polyols such as for example mannitol and maltitol. The preferred alternative however is saccharose.

Advantageously, the amount of sugaring agent of the fatty stuffing according to the present invention is comprised between 10 and 45% by weight based on the total weight of the fatty stuffing, more advantageously between 20 and 40% by weight based on the total weight of the fatty stuffing, still more advantageously between 20 and 33% by weight based on the total weight of the fatty stuffing.

In the sense of the present invention, by “fruit” is meant any “natural” fruit excluding fruit with shells (walnuts, hazelnuts, almonds, cashew nut, pecan nut . . . ). Candied fruit is excluded. This is for example red fruit such as strawberries, raspberries, blueberries, or blackberries, exotic fruit such as pineapple, mango or kiwi, melon, peach, apricot, banana, cherries, apples, pears, citrus fruit such as orange, lemon, grapefruit or clementine, grapes, plums, cherry plums, figs. Advantageously, this is red fruit.

In the sense of the present invention, by “fruit powder” is meant any fruit as defined above, dried and reduced into powder and the water content of which is less than 8% by weight based on the total weight of the fruit powder, in an advantageous way less than 5% by weight based on the total weight of the fruit powder, even more advantageously less than 3.5% by weight based on the total weight of the fruit powder, still more advantageously less than 2% by weight based on the total weight of the fruit powder. The fruit powder is distinguished from fruit pieces by finer grain size. Thus its D₉₀ is <500 μm, advantageously <250 μm, in an advantageous way <120 μm, even more advantageously <60 μm. Fruit purees are also excluded because they contain a water content >8% by weight.

Quite obviously, the fruit powder may be obtained by drying the totality of the edible portion, or by drying only one part of the edible portion, for example the juice or the pulp (residue after extracting the juice). Advantageously, the invention will use the totality of the edible part.

D₉₀ is the diameter below which 90% of the volume of all the particles of a powder is found.

Advantageously, the fruit powder is totally dehydrated. Advantageously, the fruit of the powder is in a freeze-dried form which gives a more intense and more natural aromatic note and colors to the final product.

In an advantageous way, the amount of fruit powder of the fatty stuffing according to the present invention is comprised between 5 and 15% by weight based on the total weight of the fatty stuffing, advantageously between 8 and 15% by weight based on the total weight of the fatty stuffing.

In the sense of the present invention, by “fruit equivalent” is meant the dry material (DM) of the applied fruit/DM of the fruit in the natural condition.

For example: natural strawberry has 10% DM and 90% water. Using 5.15% of a strawberry powder with 3% water, i.e. having 97% of fruit DM in a finished product gives a fruit equivalent of (97/10)*5.15%=50%.

Thus, advantageously, the fatty stuffing according to the present invention contains a fruit equivalent above 30%, advantageously above 50% and even above 100%.

With the low or zero non-fatty dry cocoa content of the fatty stuffing according to the present invention, it is possible to avoid brown coloration of the fatty stuffing so that the latter may exclusively be colored by the presence of the fruit powder. The fatty stuffing according to the present invention thus has the “natural” color of the fruit which flavors it.

Advantageously, the Aw of the fatty stuffing according to the present invention is less than 0.60, advantageously less than 0.50 and in an advantageous way less than 0.35.

The activity of the water of a product is a notion which is well known in the food industry field, this quantity, abbreviated as Aw, measures the availability of water in a sample. In most cases, this water activity is not proportional to the water content of the product.

The methods with which the Aw of a product may be measured are known to one skilled in the art. For fatty stuffings, which are relatively impervious to water, the measurement method according to the invention consists of exposing the largest possible surface area to air (for example by crumbling the fatty stuffings) and of measuring Aw at 25+/−2° C. with a Novasina™, an apparatus which leaves sufficient time (24 h) for balancing water between the sample and the air.

The fatty stuffing according to the present invention contains dry starch and/or dairy derivatives as a powder and/or milk powder, the (milk powder+dairy derivative powder+dry starch) content being larger than 25% by weight based on the total weight of the fatty stuffing. Advantageously, the (milk powder+dairy derivative powder+dry starch) content of the fatty stuffings according to the invention is larger than 30% by weight based on the total weight of the fatty stuffing, advantageously larger than 35% by weight based on the total weight of the fatty stuffing, in an advantageous way larger than 40% by weight based on the total weight of the fatty stuffing.

With these contents, for nutritional reasons, the amounts of sugaring agent of the fatty stuffing according to the invention may be reduced while providing the “filler agent” function generally provided by the sugars.

Moreover, it is not obvious to strongly increase the milk protein content in the fatty stuffing, notably because of a viscosity/yield stress increase during the storage of liquid (molten fat), and this all the more so since the storage temperature is high and all the more since the water content of the fatty stuffing increases or the FM content decreases. This is well known to one skilled in the art of chocolate-making; whence the benefit of filler agents such as starch or fibers.

It was therefore not obvious to combine both a large amount of milk powder and a significant amount of fruit powder and/or starch. Indeed:
starch provides a large amount of water (but the inventors have discovered that the latter is highly bound, which explains that it does not pose any problem)
in order to entirely preserve the color and the flavor of the fruit, it is preferable not to heat the fatty stuffing above 55° C., preferably above 45° C., which limits the possibility of evaporation of the water which normally occurs during conching.
the fruit and milk powders increase the viscosity of the fatty stuffing.

In the sense of the present invention, by “dry starch” is meant starch which does not contain water and which has therefore been entirely dried. The dry starch according to the present invention is advantageously added as native and/or non-gelatinized overdried starch, optionally thermized for lowering its microbial load.

One skilled in the art is aware of different techniques for recognizing non-gelatinized starch; the simplest one is observing it with a microscope in polarized light: the non-gelatinized grains appear as “Malta crosses” (birefringency), while gelatinized grains lose this characteristic.

It is thus possible within the scope of the present invention to replace a significant portion of the sugars traditionally in fatty stuffing with native or physically modified starch without altering the sweet flavor of the product. By adding starch, it is thereby possible to substantially reduce the fat content of the fatty stuffing according to the invention.

Unlike sugars, starch is not sweet and does not melt in the mouth and it is therefore surprising that the fatty stuffing according to the invention has similar or even better organoleptic characteristics than conventional products.

Any type of starch may be used, and notably wheat starch, maize starch, waxy corn starch, tapioca starch, rice starch, potato starch or mixtures thereof.

Advantageously, native starch, i.e. non-gelatinized starch, is used and this starch will not be gelatinized during the subsequent process. Unlike syrups of glucose, with maltodextrins and proteins, native starch absorbs very little saliva in the mouth and therefore does not increase the stickiness of the fatty stuffing. Further, as native starch is a non-modified natural product, it is not part of food additives, which have to be reported as such on the package of the marketed product.

Further, native starch does not have any digestive drawbacks, unlike polyols which have a laxative effect, which is particularly undesirable in products which are intended for children. The fact that it is not cooked makes natural starch slowly digestible, which allows a reduction of the glycemic index of the fatty stuffing according to the present invention. Thus, addition of native starch in the fatty stuffing according to the invention causes as an additional effect a sensation of satiety which is extended relatively to conventional fatty stuffings. Further, the density of native starch is high and its granules do not have porosity accessible to fat. This lack of accessible porosity is important in order not to increase the viscosity of the fatty stuffing following inclusion of fat into the pores.

The grain size of granules of native starches, which is generally comprised between 2 μm and 100 μm, and more generally between 5 μm and 45 μm, is also ideal for a use in the fatty stuffing according to the invention. Thus, native starches neither comprise too many fine particles nor too many large particles. The presence of fine particles increases the viscosity of the fatty stuffing and therefore requires an increase in the fat content. Conversely, the presence of large particles gives to the fatty stuffing a sandy sensation in the mouth. The balance between small size and large size granules may, if need be, be adjusted according to the sought textures and properties, by mixing in different proportions, starches from various origins.

In an advantageous embodiment, the particle size of the starch is for at least 90% of the particles, comprised between 2 μm and 100 μm, preferably between 5 μm and 45 μm.

Among native starches, wheat starch is preferred, because it has an ideal grain size from 2 μm to 45 μm, and because it is a natural constituent in cereal cooking products, which are mainly based on wheat flour, moreover often mixed with wheat starch.

Maize and manioc starches are also part of the preferred starches because of their grain size.

Other advantages of native starch are its neutral flavor and its white color, which allows the fatty stuffing according to the present invention to assume the taste and the color of the fruit powder. Finally, native starch is an inexpensive ingredient; and it may often be used without any grinding in the fatty stuffing according to the invention, which allows a simplified making process and larger productivity.

In addition to native starch, overdried starches, i.e. non-cooked starches may also be used according to the invention, for which the humidity content was brought below their relative equilibrium humidity. The use of a mixture of native starches and of overdried starches or of different types of overdried starches may also be contemplated.

Native wheat starch contains about 13% of water and 87% of starch nutrient. In the sense of the invention, one speaks of dry starch in order to avoid any confusion, because dry starch=starch nutrient. According to the invention up to 40% by weight of dry starch may therefore be provided, i.e. a native wheat starch content of about 46% by weight.

In certain fatty stuffings according to the invention, all or part of the starch may be brought as a non-gelatinized native flour rich in starch, for example a cereal flour, such as wheat, rice, or maize flour. Wheat flour may be assimilated to a mixture of 12% by weight of proteins, of 83% of starch with 13% of water, of 1% of fats and of 4% of fibers. Optionally, this flour may be overdried and/or it may be thermized (in order to lower its microbial load). By thermized flour is meant a flour, which was subject to a heat treatment in order to lower its microbial load, without gelatinizing its starch. Preferably, these non-gelatinized flours are cereal flours.

Starch alone however is the preferred version over the version containing only flour or flour and starch, because this gives products which are a little less sticky in the mouth and a little more neutral in taste.

It was not obvious to be able to use non-overdried starch (or flour) because the starch contains water, generally from 13% to 20% water, which results in that the introduction of 15% of wheat starch (containing 13% of water) in a formulation for example provides about 2% water in the formulation. Now, it is well known that by adding such an amount of water directly in free form, or in the form of a honey or a sugar syrup for example, causes “solidification” of the fatty stuffing, and causes risks of saponification in the presence of lauric FMs notably (very often used in fatty stuffings). Surprisingly and unexpectedly, none of these problems is encountered during the use according to the invention of a starch or flour in the fatty stuffing according to the invention.

As indicated earlier, by adding starch in the fatty stuffing according to the invention, it is further possible to reduce the sugar and fat content of the fatty stuffing.

In a particular embodiment, the fatty stuffing according to the present invention, contains between 1 and 40% by weight of dry starch based on the total weight of the fatty stuffing, advantageously between 5 and 30% by weight based on the total weight of the fatty stuffing, in an advantageous way between 13 and 22% by weight relatively to the total weight of the fatty stuffing.

In the sense of the present invention, by “dairy derivatives as a powder” is meant any product derived from milk and appearing as a powder (non-limiting examples: milk powder either skimmed or not, lactoserum, lactose, buttermilk, caseinates, concentrates of total or serum proteins . . . ). The AMF provided alone is not included, on the other hand the milk FM provided via whole milk powder is comprised in this definition. By extension, the dry material from the milk provided as a liquid and dried during the method for making the fatty stuffing according to the present invention is also included.

Dairy derivatives provide lactose (sugar), but also interesting nutrients such as proteins and calcium.

In an advantageous embodiment of the invention, the fatty stuffing according to the invention contains milk powder and/or dairy derivatives in a content comprised between 5 and 40% by weight based on the total weight of the fatty stuffing, advantageously between 10 and 35% by weight based on the total weight of the fatty stuffing, in an advantageous way between 15 and 30% by weight based on the total weight of the fatty stuffing.

In an advantageous way, the fatty stuffing according to the invention further contains at least one emulsifier, advantageously selected from lecithin, PGPR (polyglycerol polyricinoleate) or ammonium phosphatide. In a certain range, the viscosity of the fatty stuffing is adjusted by the FM content and/or by adding emulsifiers (well known to one skilled in the art).

Advantageously, the emulsifier is present in an amount <1% by weight based on the total weight of the fatty stuffing according to the invention, in an advantageous way in the case of PGPR, <0.5% by weight based on the total weight of the fatty stuffing according to the invention.

Advantageously, the fatty stuffing according to the invention contains more than 120 mg of elementary calcium for 100 g of fatty stuffing, advantageously more than 400 mg for 100 g of fatty stuffing, and preferably more than 1,000 mg for 100 g of fatty stuffing. The calcium may stem from milk powder or from dairy derivatives. It is also possible to reinforce the calcium with a calcium concentrate of dairy origin or preferably with non-dairy calcium which may be (non-exhaustively): calcium carbonate or calcium citrate powders. In this case, the fatty stuffing according to the invention contains a calcium source other than milk or dairy derivatives.

In a particular embodiment, no fruit flavoring other than the one already naturally present in the fruit powder is added into the fatty stuffing.

In an advantageous way, the fatty stuffing does not contain any food additives other than the emulsifiers.

Also advantageously no coloring agent, other than the one naturally present in the fruit powder is added into the fatty stuffing according to the present invention. Advantageously, the fatty stuffing according to the present invention does not contain any coloring agent considered as an additive in European legislation according to the 94/36/EC Directive as of 30.06.94, and bearing a code E.

Advantageously, the water content of the fatty stuffing according to the invention, is less than or equal to 6% by weight based on the total weight of the fatty stuffing. Advantageously, the fatty stuffing according to the invention contains less than 1% by weight based on the total weight of the fatty stuffing, of water as droplets, preferably less than 0.2%.

Advantageously, the saturated fatty acid content of the fatty stuffing according to the invention is less than 50% by weight, preferably less than 40% by weight, advantageously less than 30% by weight, and especially less than 20% based on the total weight of the fatty acids.

The present invention further relates to a method for making a fatty stuffing according to the invention characterized in that 3 to 20% by weight of fruit powder having a D₉₀ less than 500 μm and a water content less than 8% by weight are added to the fatty stuffing or the spread containing fat, a sugaring agent and milk powder and/or dairy derivative powder and/or dry starch and possibly non-fatty dry cocoa, the mixing and storage temperature not exceeding 55° C. for more than 30 minutes, advantageously not exceeding 45° C. for more than 30 minutes. Preferably, the whole making process and the storage are at less than 55° C., advantageously at less than 45° C. With this, the color and the flavor of the fruit may be preserved and the aggregates (lumps) which have then to be sieved or ground again, may be limited on the other hand. If the fruit powder is fine enough, it is added after the steps for grinding the other ingredients.

Preferably, the fruit powder has a water content less than 5%, preferably less than 3.5%, advantageously less than 2%. As the fruit powders are very hygroscopic, precautions should be taken in order to avoid their re-hydration (brief storage before opening, reduced relative humidity of the air . . . ).

In another advantageous method for making the fatty stuffing according to the present invention, entire pieces of fruit or large pieces of fruit having the water content of the fruit powder according to the present invention (i.e. less than 8% by weight), are added into the fatty stuffing and then ground during the method for making the fatty stuffing according to the invention so as to obtain the desired D₉₀. Advantageously, a portion of the lecithin is added before this grinding.

Advantageously, within the scope of the making methods according to the present invention, the fruit used is freeze-dried fruit.

The present invention further relates to the use of the fruit-based fatty stuffing according to the invention as stuffing in biscuit products, pastries, bars, candies kept at room temperature or refrigerated.

In the sense of the present invention by “biscuit product” is meant dry biscuits, wafers, rusks, crackers, cookies, cereal bars (with or without fruit) etc.

The present invention finally relates to the use of the fruit spread according to the invention on bread, bread substitutes (rusks and crackers), or as a dip for biscuit sticks, for example bretzels.

The following example illustrates the invention and in particular the preparation method and the uses of the fatty stuffings according to the invention.

### EXAMPLE 1

### Srawberry-Flavored Spread and Fatty Stuffing

A strawberry-flavored spread and stuffing are made with the ingredients grouped together in the following Table 1:

TABLE I
List of the ingredients and proportions (weight %)

| Ingredients | % |
|---|---|
| Non-hydrogenated rapeseed oil | 19.5 |
| AMF | 6.5 |
| Lecithin | 0.3 |
| PGPR | 0.05 |
| Icing sugar (saccharose) | 23.0 |
| Non-gelatinized native wheat | 12.15 |
| starch containing 13% of water | |
| Fructo-oligosaccharides | 7 |
| Skimmed mild powder (1% water) | 21.0 |
| Freeze-dried strawberries as | 7.5 |
| a powder (1.5% water) | |
| Ground calcium carbonate | 3 |
| Total | 100 |

Nutritional analysis:
FM: 26.6%
Sugaring agents: 38.4%
   Including added sugars (not included in the non-refined ingredients, such as fruit and milk): 23%
Dry starch: 10.6%
Fruit equivalent: ˜70%
Dairy derivatives as a powder: 21%
Saturated fatty acids: ˜22% of the total fatty acids.

The making method was the following:

Mix the ingredients at 35° C.: first all the ingredients except for the freeze-dried fruit powder, and then gradually add the fruit when the spread is formed. Mixing with the Kenwood, a blade type mixer, takes about 4 min.

Depending on the grain size of the different powders, the PGPR dose may be adjusted (0-0.4%) in order to obtain the desired yield stress: the finer the powders, the more PGPR is needed for a given yield stress.

Perform the deposition on a biscuit (stuffing) or put it into pots (spread) at this same temperature. Cooling and storage at 18° C.

This product may be used as such as a spread (a substitute for Nutella), or as a stuffing in sandwiched bars or biscuits (replacement of the stuffing of stuffed snacks).

The product keeps for at least 3 months at 18-20° C.

1. A fruit-based fatty stuffing or spread consisting of a suspension of solid particles in a continuous fatty phase, comprising (i) at least one sugaring agent with a content of less than 45% by weight: (ii) non-fatty dry cocoa with a content of less than 3% by weight; and (iii) fat with a content from 23% to 38% by weight,
wherein the fruit-based fatty stuffing or spread further contains (iv) milk powder and/or dairy derivative powder and/or dry starch, and (v) fruit powder with a content between 3% and 20% by weight, the fruit powder having a D₉₀ less than 500 μm and a water content less than 8% by weight, and the (milk powder+dairy derivative powder+dry starch) content being above 25% by weight.

2. The fruit-based fatty stuffing or spread according to claim 1, wherein its Aw is less than 0.60.

3. The fruit-based fatty stuffing or spread according to claim 1, wherein it contains between 1% and 40% by weight of dry starch.

4. The fruit-based fatty stuffing or spread according to claim 1, wherein its (dairy derivative powder+milk powder+dry starch) content is above 30% by weight.

5. The fruit-based fatty stuffing or spread according to claim 1, wherein its sugaring agent content is from 10% to 45% by weight.

6. The fruit-based fatty stuffing or spread according to claim 1, wherein its fat content is from 23% to 35% by weight.

7. The fruit-based fatty stuffing or spread according to claim 1, wherein it further contains at least one emulsifier.

8. The fruit-based fatty stuffing or spread according to claim 1, wherein it contains more than 120 mg of elementary calcium for each 100 g of fatty stuffing or spread.

9. The fruit-based fatty stuffing or spread according to claim 1, wherein its saturated fatty acid content is less than 50% by weight based on the total weight of the fatty acids.

10. The fruit-based fatty stuffing or spread according to claim 1, wherein it does not contain any coloring agent considered as additives in European legislation.

11. The fruit-based stuffing or spread according to claim 1, wherein the pieces of fruit of the fruit powder are in freeze-dried form.

12. A method for making the fruit-based fatty stuffing or spread according to claim 1, comprising:
(a) adding 3% to 20% of fruit powder having a D₉₀ less than 500 μm and a water content less than 8% by weight to the fatty stuffing or spread containing fat, a sugaring agent, milk powder and/or dairy product powder and/or starch, and optionally non-fatty dry cocoa;
(b) mixing the fruit powder and fatty stuffing or spread of step (a) at a mixing temperature; and
(c) optionally storing the mixture of step (b) at a storing temperature,
wherein the mixing temperature and storage temperature do not exceed 55° C. for more than 30 minutes.

13. The method according to claim 12, wherein the fruit used is in freeze-dried form.

14. A stuffing for biscuit product, pastry, bar, or candy kept at room temperature or refrigerated which contains the fruit-based fatty stuffing according to claim 1.

15. A spread for bread or bread substitute or a dip for biscuit sticks which contains the fruit-based spread according to claim 1.

16. The fruit-based fatty stuffing or spread according to claim 1, wherein its non-fatty dry cocoa content is less than 1% by weight.

17. The fruit-based fatty stuffing or spread according to claim 2, wherein its Aw is less than 0.35.

18. The fruit-based fatty stuffing or spread according to claim 3, wherein the fruit-based fatty stuffing or spread contains between 13% and 22% by weight of dry starch.

19. The fruit-based fatty stuffing or spread according to claim 4, wherein its (dairy derivative powder+milk powder+dry starch) is above 40% by weight.

20. The fruit-based fatty stuffing or spread according to claim 5, wherein its sugaring agent content is from 20% to 33% by weight.

21. The fruit-based fatty stuffing or spread according to claim 6, wherein its fat content is from 26% to 30% by weight.

22. The fruit-based fatty stuffing or spread according to claim 7, wherein the emulsifier is selected from lecithin, PGPR, and ammonium phosphatide.

23. The fruit-based fatty stuffing or spread according to claim 8, wherein the fruit-based fatty stuffing or spread contains more than 400 mg of elementary calcium for 100 g of fatty stuffing or spread.

24. The fruit-based fatty stuffing or spread according to claim 8, wherein its elementary calcium content is more than 1,000 mg for 100 g of fatty stuffing or spread.

25. The method according to claim 12, wherein the mixing temperature and storage temperature do not exceed 45° C. for more than 30 minutes.
